(19) United States
(12) Patent Application Publication
(10) Pub. No.: US 2025/0314537 A1
(43) Pub. Date: Oct. 9, 2025

(54) SYSTEMS AND METHODS FOR A THERMOCOUPLE EMBEDDED TESTING DEVICE

(71) Applicant: Ford Global Technologies, LLC, Dearborn, MI (US)

(72) Inventors: Keonseok Oh, Novi, MI (US); Kwon Shon, Troy, MI (US); Chi Paik, Grosse Ile, MI (US)

(21) Appl. No.: 18/629,449

(22) Filed: Apr. 8, 2024

(51) Int. Cl. G01K 7/02; G01K 1/08; G01K 1/14; H01M 10/48

(52) U.S. Cl. CPC G01K 7/023; G01K 1/08; G01K 1/14; H01M 10/486

(57) ABSTRACT

Methods and systems are provided for thermocouple embedded testing devices that may be incorporated into a fixture assembly for temperature testing of battery cells to prevent degradation of thermocouples. In one example, a thermocouple embedded testing device may comprise a bolt including a head portion filled with a first material and a threaded portion filled with a second material, and a thermocouple positioned within the bolt and extending from the head portion to the threaded portion.

### FIELD

The present description relates generally to systems and methods for a thermocouple embedded testing device which may be incorporated into a fixture assembly.

### BACKGROUND/SUMMARY

Battery cell evaluation, for example of a lithium ion battery, may include testing temperature changes during operation. A method for measuring temperatures of lithium ion batteries may involve using tape for attachment of an end of a thermocouple to an area of a battery cell to be measured. However, under some conditions, such as in high or low-temperature environments and/or high humidity environment, reduction in adhesion of the tape may disrupt attachment of the thermocouple to the battery cell, resulting in inadequate temperature measurement results. Additionally, the above method may include placing the thermocouple between the battery cell and an aluminum fixture, which may lead to degradation of the battery cell due to electrode compression during repeated charge and discharge cycles. Moreover, thermocouples with a thin, wire-like shape may be susceptible to breakage from repeated stress when placed between the battery cell and the aluminum fixture.

In one example, the issues described above may be at least partially addressed by a thermocouple embedded testing device, comprising: a head portion filled with a first material; a threaded portion filled with a second material; and a thermocouple positioned within the testing device and extending from the head portion to the threaded portion. In this way, the thermocouple embedded testing device may be utilized in a fixture to allow for securement of the thermocouple to a battery cell during testing without causing degradation of the battery cell or the thermocouple. Further, the thermocouple embedded testing device may ensure contact is maintained between the thermocouple and the battery cell, thus increasing thermocouple sensitivity, especially under conditions in which tape adhesion may be reduced.

As one example, a fixture for thermal measurement of a battery cell may include a top plate and a bottom plate fixed at a distance from one another by fasteners with the battery cell interposed between the top plate and the bottom plate. Thermocouple embedded testing devices may be placed in holes in the top plate and the bottom plate such that the thermocouples thereof may extend through the thicknesses of the top plate and bottom plate and be in face sharing contact with the battery cell. In this way, temperature of the battery cell may be measured at the areas which are in face sharing contact with the thermocouples.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a cross section of an example of a fixture assembly, including a top plate, a bottom plate, and a thermocouple embedded testing device according to the present disclosure.

FIGS. 2A and 2B show a bolt body of the thermocouple embedded testing device.

FIGS. 3A and 3B show cross section and top views, respectively, of the thermocouple embedded testing device.

FIG. 4 shows an exploded view of the fixture assembly.

FIGS. 5A and 5B show a top view and a cross section view, respectively, of the top plate of the fixture assembly.

FIGS. 6A and 6B show a bottom view and a cross section view, respectively, of the bottom plate of the fixture assembly.

FIG. 7 shows a flowchart of a method of forming a thermocouple embedded testing device.

FIG. 8 shows the fixture assembly with a battery cell.

### DETAILED DESCRIPTION

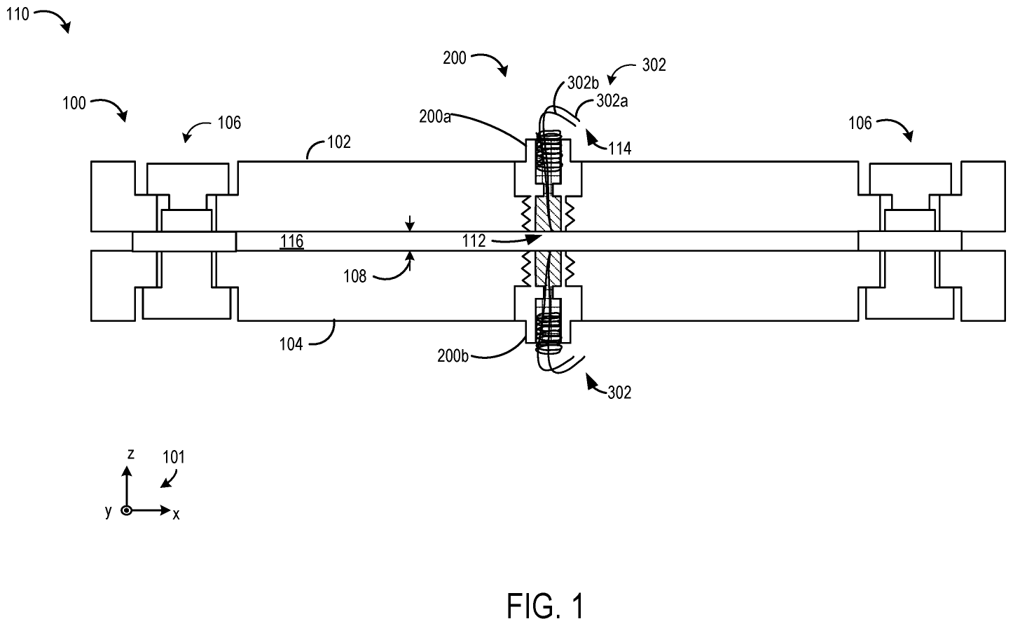

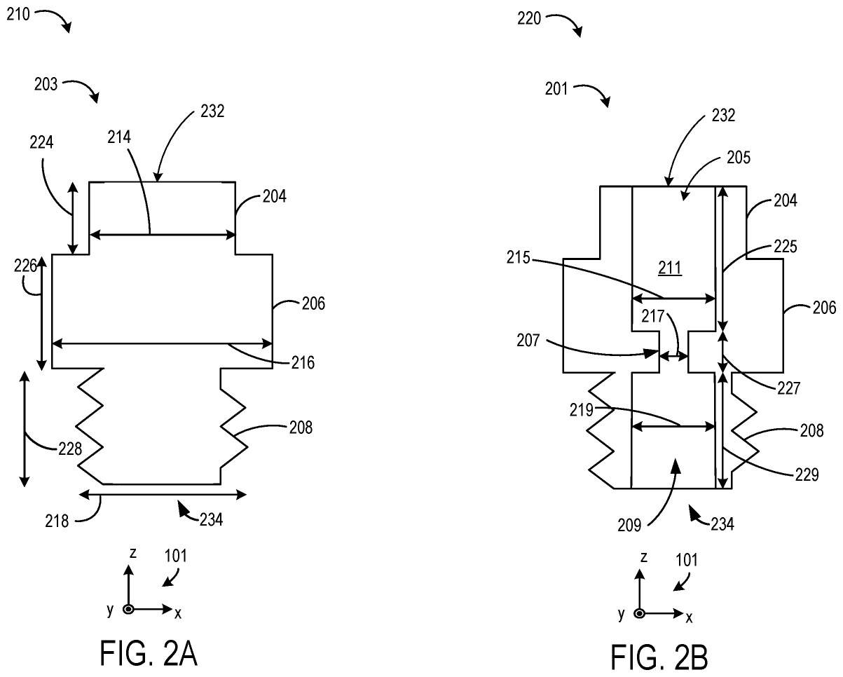

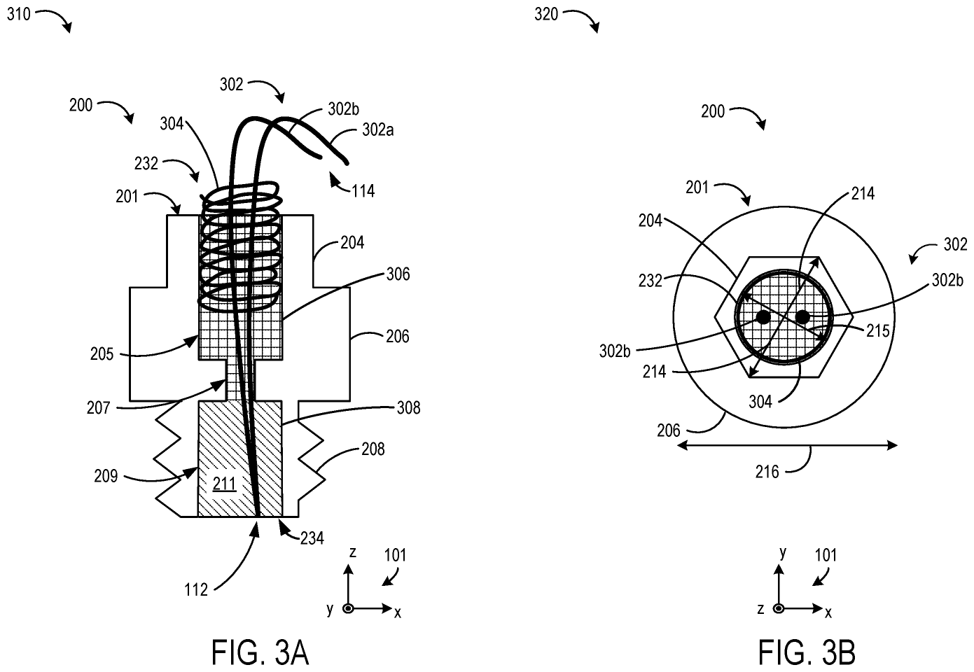

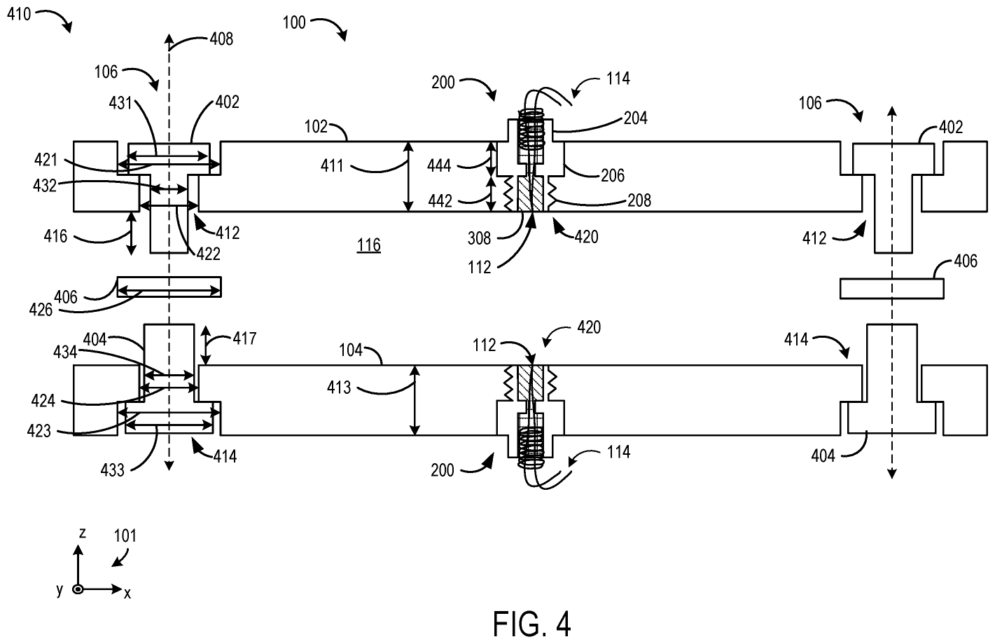

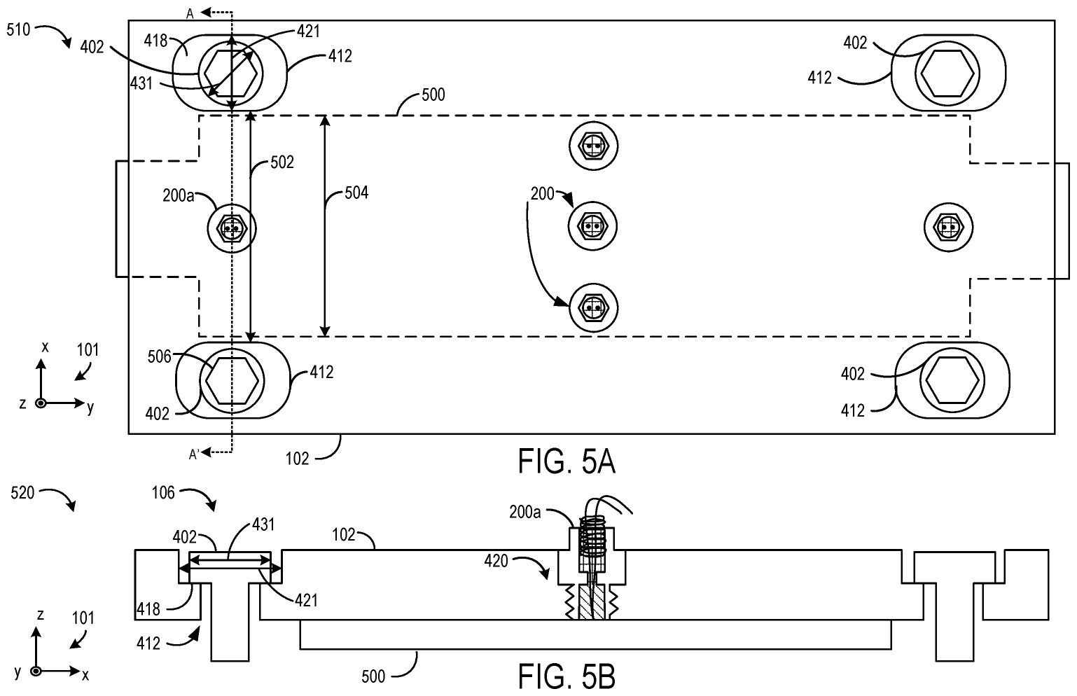

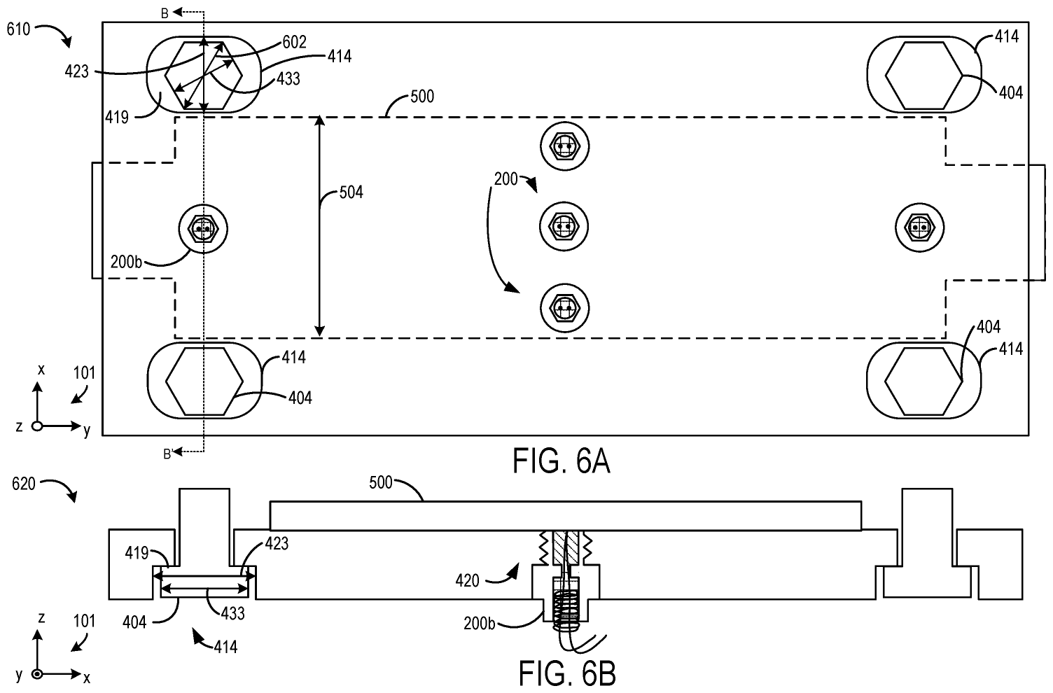

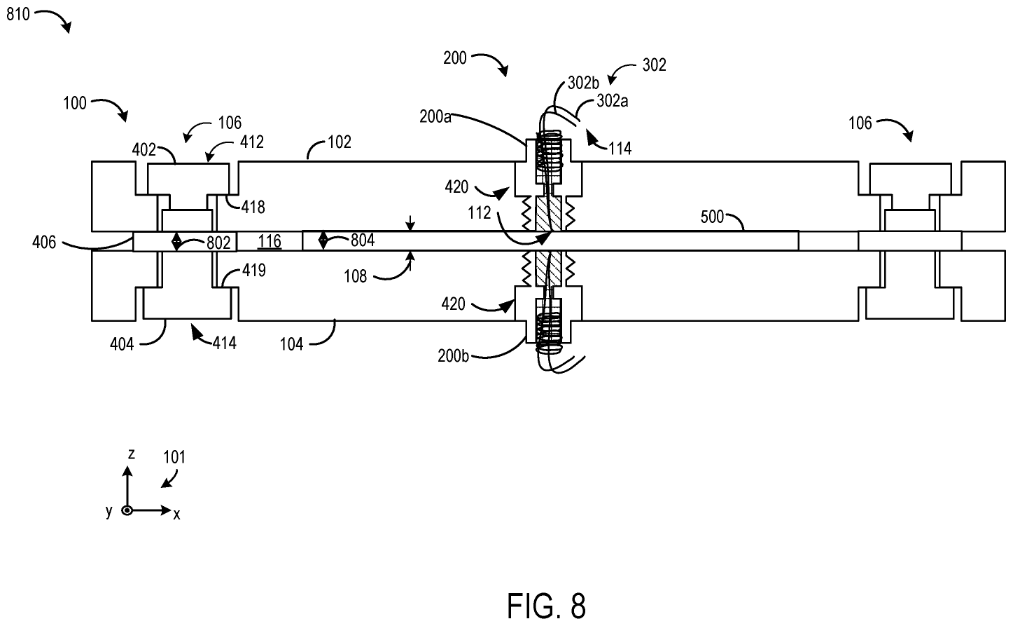

The following description relates to a thermocouple embedded testing device. For example, the thermocouple embedded testing device may be incorporated into a fixture assembly for battery temperature testing. An exemplary fixture assembly which includes a top plate, a bottom plate, a plurality of fasteners, and one or more thermocouple embedded testing devices, is shown in FIG. 1. The fixture assembly is further shown in an exploded view in FIG. 4. A battery cell may be interposed between the top plate and the bottom plate and the thermocouple embedded testing devices may be inserted into the top plate and the bottom plate such that the thermocouple embedded testing devices may measure the temperature of the battery cell. FIG. 8 shows a battery positioned in the fixture assembly. The top plate and the battery cell are further shown in two views in FIGS. 5A and 5B, the bottom plate and the battery cell are further shown in two views in FIGS. 6A and 6B, and the thermocouple embedded testing device is further shown in FIGS. 3A and 3B. The thermocouple embedded testing device may include a bolt body which is described in reference to FIGS. 2A and 2B.

FIGS. 1-6B show references axes 101, including an x-axis, a y-axis, and a z-axis. For example, the x-axis and y-axis may be horizontal axes, and the z-axis may be a vertical axis that is parallel to a direction of gravity. However, the reference axes 101 may have other orientations.

It is also to be understood that the specific assemblies and systems illustrated in the attached drawings, and described in the following specification are exemplary embodiments of the inventive concepts defined herein. For purposes of discussion, the drawings are described collectively. Thus, like elements may be commonly referred to herein with like reference numerals and may not be re-introduced.

Turning to FIG. 1, a cross section view 110 of an exemplary fixture assembly 100 is shown, including a top plate 102, a bottom plate 104, a plurality of fasteners 106 adapted to fasten the top plate 102 and the bottom plate 104 together, and one or more thermocouple embedded testing devices 200. In the fixture assembly 100, a first group of the thermocouple embedded testing devices 200 may be fastened into the top plate 102 and a second group of the thermocouple embedded testing devices 200 may be fastened into the bottom plate 104. The fasteners 106 may each extend through the top plate 102 and the bottom plate 104 and fix the top plate 102 and the bottom plate 104 in parallel x-y planes with a gap 108 maintained therebetween. The gap 108 may define an interior 116 of the fixture assembly 100. A battery cell, such as a battery cell 500 shown in FIG. 5A, to be tested, such as a lithium ion battery cell, may be interposed between the top plate 102 and the bottom plate 104, in the interior 116. As depicted in FIG. 1, each of the thermocouple embedded testing devices 200 may extend through either the top plate 102 or the bottom plate 104. A first group of thermocouple embedded testing devices 200 may extend through the top plate 102 and a second group of thermocouple embedded testing devices may extend through the bottom plate 104. For example, a first thermocouple embedded testing device 200a may extend through the top plate 102 such that a thermocouple 302 of the thermocouple embedded testing device 200a may extend through the top plate 102. In this way, a first end of 112 of the thermocouple 302 may be exposed to the interior 116, and a second end 114 of the thermocouple 302 may be exterior to the fixture assembly 100 (e.g., above the top plate 102 or below the bottom plate 104). The thermocouples 302 may each include a first wire 302a and a second wire 302b, wherein a material of the first wire 302a is not the same as a material of the second wire 302b. The first wire 302a and the second wire 302b may join at the first end 112 and may physically couple to the battery cell. Further, each of the first wire 302a and the second wire 302b at the second end 114 may electrically couple to a voltage meter (not shown). In some examples, the voltage meter may be included in a data acquisition system (DAQ). The DAQ may convert a voltage difference between the first wire 302a and the second wire 302b into a temperature value. Additionally or alternatively, the voltage meter may be included in a device that detects (e.g., measures) a voltage difference between the first wire 302a and the second wire 302b and displays a corresponding temperature value on a display of the device. In this way, temperature of an area of the battery cell which is coupled to the thermocouple 302 may be more accurately and easily detected. Similar to the first thermocouple embedded testing device 200a, a second thermocouple embedded testing device 200b may extend through the bottom plate such that a thermocouple thereof may extend through the bottom plate to measure temperature of an area of the battery cell to which the thermocouple 302 is coupled. In at least some examples, there may be more than one thermocouple embedded testing devices 200 extending through each of the top plate 102 and the bottom plate 104 as described above. For example, ten thermocouple embedded testing devices 200 may be incorporated in a fixture, such as the fixture assembly 100. Additionally, there may be five thermocouple embedded testing devices 200 integrated with the top plate 102 and five thermocouple embedded testing devices 200 integrated with the bottom plate 104. In this way, several temperature measurements of different areas of the battery cell may be collected. Such operation enables temperature testing of a greater amount area of the battery cell than may be achieved with a single thermocouple, and consequently more thorough testing results.

Turning to FIGS. 2A and 2B, a solid bolt 203 and a bolt body 201 are shown in cross section views 210 and 220, respectively. For example, the bolt body 201 may be formed by creating a hole 211 in the solid bolt 203. Additionally, the bolt body 201 may be part of a thermocouple embedded testing device, such as the first thermocouple embedded testing device 200a of FIG. 1.

As shown in FIG. 2A, the solid bolt 203 may include a hexagonal portion 204, a cylindrical portion 206, and a threaded portion 208 which may be integrally formed as shown in FIG. 2A. The hexagonal portion 204 and the cylindrical portion 206 may together be referred to herein as a head portion. The hexagonal portion 204 may be a hexagonal protrusion extending from the cylindrical portion 206. Thus, the head portion may comprise a hexagonal protrusion. For example, the solid bolt 203 material may be polypropylene (PP). The hexagonal portion 204 may have a maximal diameter 214 and a first height 224. The cylindrical portion 206 may have a diameter 216 and a second height 226. The threaded portion 208 may have an outer diameter 218 and a third height 228. In at least some examples, the first height 224, the second height 226, and the third height 228 may be approximately the same. For example, the first height 224, the second height 226, and the third height 228 may all be approximately 5 mm. The diameter 216 may be greater than both the maximal diameter 214 and the outer diameter 218. In this way, the cylindrical portion 206 may protrude radially from the bolt body 201. Such structure may enable the bolt body 201 to be fastened in a threaded hole with similar dimensions such that axial movement of the bolt relative to the threaded holes is restricted by the protruding cylindrical portion 206. Thus, the bolt body 201 may be axially fixed when tightened into the threaded hole. Additionally, centers of the hexagonal portion 204, the cylindrical portion 206, and the threaded portion 208 may be aligned along a common axis parallel to the z-axis.

The bolt body 201 may be formed from the solid bolt 203 by creating a through hole, such as the hole 211 as shown in FIG. 2B. Thus, the bolt body 201 may be hollow, and may have the same dimensions as described above for the hexagonal portion 204, the cylindrical portion 206, and the threaded portion 208. The hexagonal portion 204 may be used for tightening of the bolt body 201 into a threaded hole, for example by rotationally coupling a wrench with the hexagonal portion 204 and rotating the wrench. The threaded portion 208 may engage with threads of the threaded hole such that the bolt body 201 is secured (e.g., axially fixed) to an element (e.g., a plate) through which the threaded hole extends. Further, the bolt body 201 may also be constructed out of PP. For example, the hole 211 may extend axially through the bolt body 201 along the z-axis, and may be shaped such that the hole 211 is defined by walls of a first section 205, a second section 207, and a third section 209. The hole 211 may further be defined by a top opening 232 and a bottom opening 234. For example, the first section 205, second section 207, and third section 209 may each be cylindrical in shape with a fourth diameter 215, a fifth diameter 217, and a sixth diameter 219, respectively. In the same example, the top opening 232 and the bottom opening 234 may be circular. The fifth diameter 217 may be smaller than the fourth diameter 215 and the sixth diameter 219, in at least some examples. For example, the fourth diameter 215 may be 10 mm, the fifth diameter 217 may be 2 mm, the sixth diameter 219 may be 4 mm, though other dimensions may be used. The relative sizes of the fifth diameter 217, the fourth diameter 215, and the sixth diameter 219 may allow for easier insertion of a thermocouple and a spring into the hole 211 when forming a thermocouple embedded testing device, as discussed further below.

Further, the first section 205, the second section 207, and the third section 209 may have a fourth height 225, a fifth height 227, and a sixth height 229, respectively. As used herein, “height” may indicate the referenced dimension is parallel with the z-axis. In at least some examples, the sixth height 229 may be the same as the third height 228. Additionally or alternatively, the fourth height 225 may be less than the first height 224. Further, in at least some examples, the fourth height 225 may be greater than the sixth height 229, and the sixth height 229 may be greater than the fifth height 227. In such an example, the fourth height 225 may be 8 mm, the fifth height 227 may be 2 mm, and the sixth height 229 may be 5 mm. In other examples, other relative heights of the first section 205, the second section 207, and the third section 209 may be used.

Turning to FIGS. 3A and 3B, a cross section view 310 and a top view 320, respectively, of the thermocouple embedded testing device 200 are shown. The thermocouple embedded testing device may include the bolt body 201.

The thermocouple embedded testing device may also include a spring 304. For example, the spring 304 may be a helical, or spiral, spring oriented with an axial center parallel to the z-axis. The spring 304 may be positioned at least partially in the first section 205 such that the spring 304 circumferentially surrounds a portion of the thermocouple 302. The spring 304 may extend through the top opening 232 such that the spring 304 is partially outside of the first section 205 of the hole 211 in the bolt body 201. In some examples, the spring 304 may be in face sharing contact with the cylindrical wall which defines the first section 205. The spring 304 may not be in face sharing contact with the thermocouple 302. In this way, the spring 304 may prevent degradation of the bolt body 201. For example, because the bolt body 201 may be hollow and thin (e.g., longer in the z-direction than wide in the x-direction and the y-direction), the bolt body 201 may be susceptible to degradation upon bending. The spring 304 may prevent bending of the bolt body, thus preventing associated degradation. As such, the spring 304 may extend at least halfway through the fourth height 225. The spring 304 may further protrude outside of the bolt body 201 from the top opening 232 by a sufficient length (e.g., 10 mm). In this way, the spring 304 may resist bending in the x-direction and the y-direction, thus degradation of the thermocouple embedded testing device 200 may be prevented.

The hole 211 of the bolt body 201 may be filled with a first material 306 and a second material 308. The first material 306 may be thermally insulating and the second material 308 may be thermally conductive. For example, the first material 306 may be resin, such as epoxy resin, and the second material 308 may be a metal such as lead or lead alloy. For example, the third section 209 may be soldered with the second material 308 (e.g., filled with lead or a lead alloy) while the thermocouple is positioned as desired. The second material 308 may be sanded (e.g., with sandpaper) to produce a smooth surface without protrusions of the second material 308 beyond the end of the threaded portion 208. In this way, the first end 112 may be coplanar with the surface of the second material 308. Additionally, the first section 205 and the second section 207 may be filled with the first material 306 (e.g., epoxy resin) with the thermocouple positioned as desired. The second material 308 and the first material 306 may be in face sharing contact, such that the hole 211 is entirely filled around the thermocouple 302 and the spring 304. Further, the first material 306 and the second material 308 may surround the thermocouple 302 and space the thermocouple 302 away from the walls of the bolt body 201 which define the hole 211.

In this way, when the first material 306 solidifies, the thermocouple 302 and the spring 304 may both be fixed in place relative to the bolt body 201. In this way, the thermocouple 302 may be embedded in (e.g., axially, radially, and rotationally fixed within) the thermocouple embedded testing device 200, and protected from degradation. Further, the second material 308 may protect a joint at the first end 112 wherein the first wire 302a and the second wire 302b may be electrically coupled. Further still, the high thermal conductivity of the second material 308 may allow for heat to be transferred to the joint via the second material 308. In this way, temperature of a surface (e.g., an area of a battery cell) in face sharing contact with the second material 308 may be detected if the joint is not in face sharing contact with the surface. Additionally, due to placement of the thermally insulating first material 306 above the thermally conducting second material 308, heat loss to the exterior of the thermocouple embedded testing device 200 in the z-direction may be reduced. In this way, a more accurate temperature reading may be obtained.

Turning to FIG. 4, an exploded view 410 of the fixture assembly 100 is shown, including the top plate 102, the bottom plate 104, the fasteners 106, and the thermocouple embedded testing devices 200. The fixture assembly 100 may be disassembled as shown in FIG. 4 to place a battery cell between the top plate 102 and the bottom plate 104. The fixture assembly 100 may be reassembled (e.g., to resemble FIG. 1) and disassembled as desired by adjusting the fasteners 106. Further, the thermocouple embedded testing devices 200 are shown inserted into the top plate 102 and the bottom plate 104, however, the thermocouple embedded testing devices 200 may each be removably coupled to either the top plate 102 or the bottom plate 104 such that the thermocouple embedded testing devices 200 may be removed from the fixture assembly 100.

The top plate 102 and the bottom plate 104 may have approximately the same dimensions, in at least some examples. For example, the top plate 102 and the bottom plate 104 may be 400 mm in the y-direction, 200 mm in the x-direction, and 10 mm in the z-direction. In such an example, a first thickness 411 of the top plate 102 and a second thickness 413 of the bottom plate 104 may be approximately the same (e.g., 10 mm). In other examples, dimensions of the top plate 102 and the bottom plate 104 may not be approximately the same. The top plate 102 and the bottom plate 104 may be aluminum or aluminum alloy, and may be strengthened, for example by heat treatment.

Further, a third group of holes 420 may be included in both the top plate 102 and the bottom plate 104. For example, there may be five of the third group of holes 420 in the top plate 102 and five of the third group of holes 420 in the bottom plate 104. In other examples, there may be a different number (e.g., one or more) of the third group of holes 420 in the top plate 102 and/or the bottom plate 104. Each of the thermocouple embedded testing devices 200 may extend through and be in face sharing contact with walls that define one of the third group of holes 420. Thus, the threaded portion 208 of each thermocouple embedded testing device 200 may be adapted to removably couple with the threaded wall of one of the third group of holes 420. The third group of holes 420 may include a threaded wall which engagingly couples with the threaded portion 208 of the corresponding thermocouple embedded testing device 200 via the threads thereof. The cylindrical portion 206 may be in face sharing contact with a cylindrical wall of the corresponding hole of the third group of holes 420. Thus, the cylindrical wall may have approximately the same diameter as the cylindrical portion 206. Further, a seventh height 442 of the threaded wall may be approximately the same as the height of the threaded portion 208 (e.g., the third height 228 of FIG. 2A) and an eighth height 444 of the cylindrical wall may be approximately the same as the height of the cylindrical portion 206 (e.g., the second height 226 of FIG. 2A). Further still, the thickness 411 and the thickness 413 may both be the sum of the seventh height 442 and the eighth height 444. The hexagonal portion 204 of each thermocouple embedded testing device 200 may protrude outwards (e.g., opposite of the interior 116) for accessibility of a user to tighten the thermocouple embedded testing devices 200 within the third group of holes 420 via the threads thereof. Tightening of the thermocouple embedded testing devices 200 into the third group of holes 420 may be achieved by rotating the thermocouple embedded testing devices 200 relative to the top plate 102 or the bottom plate 104 such that more threads are engaged. In this way, each of the thermocouple embedded testing devices 200 may be secured to either the top plate 102 or the bottom plate 104 via one of the third group of holes 420 such that axial movement (e.g., in the z-direction) may be prevented. Additionally, the thermocouple embedded testing devices 200 may each be removably coupled to either the top plate 102 or the bottom plate 104 via threaded connections. Further, when the thermocouple embedded testing devices are tightened into a plate (e.g., the top plate 102 or the bottom plate 104) via the threaded connections, the thermocouples 302 of the thermocouple embedded testing devices 200 may extend through an entire thickness of the plate (e.g., the thickness 411 or the thickness 413) such that the thermocouples 302 extend from a first side of the plate to a second side of the plate opposite of the first side (e.g., an upwards facing surface of the plate to a downwards facing surface of the plate).

The threaded walls and the cylindrical walls of the third group of holes 420 may be adapted to receive the thermocouple embedded testing devices 200 such that the threaded portions 208 of the thermocouple embedded testing devices 200 are adjacent to the interior 116 of the fixture assembly 100 and the thermocouples 302 are perpendicular to the top plate 102 and the bottom plate 104. In this way, the joint at the first end 112 wherein wires (e.g., the first wire 302a and the second wire 302b) are electrically coupled may be adjacent to the interior 116. Further, the thermocouple embedded testing devices 200 may be tightened into the plates such that they are flush with interior facing surfaces (e.g., surfaces which define the interior 116). For example, a thermocouple embedded testing device 200 tightened (e.g., fastened) into the top plate 102 may have an end of the threaded portion 208 in the same plane as a surface of the top plate 102 that faces the bottom plate 104. Thus, the first end 112 of the thermocouple 302 may be coplanar with both the exposed surface of the second material 308 and the top plate 102. In this way, the second material 308 (e.g., solder metal) may be adjacent to the interior 116 and when the fixture assembly 100 is assembled, the thermocouple 302 may detect (e.g., sense) the temperature of a battery cell (e.g., a lithium ion battery cell) positioned in the interior 116 and in face sharing contact with the top plate 102 and the bottom plate 104. The thermocouple 302 may further transmit a corresponding electrical signal via the second end 114 according to the detected temperature. The electrical signal may be sent to a DAQ, a voltage meter, and/or a device as described above, for examples.

The top plate 102 and the bottom plate 104 may also include a first group of holes 412 and a second group of holes 414, respectively, through which the fasteners 106 may extend. The first group of holes 412 may include multiple holes which may be shaped approximately the same as one another. Likewise, the second group of holes 414 may include multiple holes which may be shaped approximately the same as one another. The top plate 102 and the bottom plate 104 may be arranged such that the first group of holes 412 and the second group of holes 414 may be aligned. For example, as shown in FIG. 4, one of the first group of holes 412 and one of the second group of holes 414 may be axially aligned with centers along a vertical axis 408. Each of the fasteners 106 may include a bolt 402, a nut 404, and a washer 406 which may be axially aligned with centers thereof along a vertical axis, such as the axis 408.

For example, the first group of holes 412 may each be defined by two cylindrical (or cylindroid) walls which have a first diameter 421 and a second diameter 422, wherein the first diameter 421 may be greater than the second diameter 422. The bolts 402 may each have a bolt head with a bolt head diameter 431 and a bolt body with a bolt body diameter 432, wherein the bolt head diameter 431 is greater than the bolt body diameter 432. The first group of holes 412 may be larger than the bolts 402 such that the first group of holes 412 are adapted to receive the bolts 402 as shown, and allow the bolts to rotate relative to the top plate 102. The bolt head diameter 431 may be greater than the second diameter 422 and less than the first diameter 421. The bolts 402 may each extend through the thickness 411 via one of the first group of holes 412 and may further extend beyond the top plate 102 towards the bottom plate 104 by a first distance 416.

The second group of holes 414 may each be defined by two cylindrical (or cylindroid) walls which have a third diameter 423 and a fourth diameter 424, wherein the third diameter 423 may be greater than the fourth diameter 424. In some examples, cross sections (e.g., in an x-y plane) of the first group of holes 412 and the second group of holes may not be circular, but rather elliptical, rounded rectangle, or the like. In such examples, the first diameter 421, the second diameter 422, the third diameter 423, and the fourth diameter 424 may be minor axes (e.g., the smallest diameters of their respective walls). The nuts 404 may each have a nut head with a nut head diameter 433 and a nut body with a nut body diameter 434, wherein the nut head diameter 433 is greater than the nut body diameter 434. For example, the heads of the nuts 404 may be hexagonal in shape, and the nut head diameter 433 may be a minimal diameter thereof. The second group of holes 414 may be larger than the nuts 404. For example, the nut head diameter 433 may be greater than the fourth diameter 424 and less than the third diameter 423. The nuts 404 may each extend through the thickness 413 via the second group of holes 414 and may further extend beyond the bottom plate 104 towards the top plate 102 by a second distance 417.

The nut body of each of the nuts 404 may be adapted to receive the threaded body of one of the bolts 402. For example, the nuts 404 may have female threads that are complementary to male threads on the bolts 402 such that the nuts 404 and bolts 402 may be engagingly coupled via threaded connection. Further, the second distance 417 may be large enough for each nut 404 to cover at least approximately half of the threads of the corresponding bolt 402 when the fixture assembly 100 is assembled as shown in FIG. 1.

The washers 406 may have an outer diameter 426 that is greater than the second diameter 422 and the fourth diameter 424. For example, the outer diameter 426 may be 13.2 mm. Further, the washers 406 may have an inner diameter that is greater than the nut body diameter 434 so that the washers 406 may circumferentially surround the nuts 404 and be sandwiched between the top plate 102 and the bottom plate 104 when the fixture assembly 100 is assembled.

For example, as shown in FIG. 8 which depicts a cross section view 810 of the fixture assembly 100 assembled with a battery cell 500 positioned in the interior 116, the washers 406 may be positioned vertically between the top plate 102 and the bottom plate 104 such that the gap 108 may be maintained by the washers 406.

The bolts 402 may be in face sharing contact with the top plate 102, for example at a surface 418, and the nuts 404 may be in face sharing contact with the bottom plate 104, for example at a surface 419, such that the bolts 402 and the nuts 404 may apply opposite axial compressive forces (e.g., parallel to the z-axis) which hold the top plate 102 and the bottom plate 104 together when the fixture assembly 100 is assembled (e.g., when the fasteners 106 are tightened). Further, the axial compressive forces may hold a battery cell to be tested (e.g., the battery cell 500) in place between the top plate 102 and the bottom plate 104. The washers 406 may have a thickness 802 that is approximately the same as a thickness 804 of the battery cell 500, or another battery cell to be tested in the fixture assembly. In this way, the washers 406 may prevent axial compressive forces from reducing the gap 108 below approximately the thickness 804 and causing degradation of the battery cell 500.

The axial compressive forces may also allow the battery cell 500 to be in face sharing contact with the top plate 102 and the bottom plate 104 such that the battery cell 500 is in face sharing contact with ends of thermocouples 302 of the one or more thermocouple embedded testing devices 200. Thus, by circumventing placing thermocouples between the top plate 102 and the bottom plate 104 where axial compressive forces may be experienced, and instead positioning the thermocouples approximately perpendicularly to the top plate 102 and the bottom plate 104, the thermocouples within the thermocouple embedded testing devices 200 may be protected from degradation. Further, the ability to tighten the thermocouple embedded testing devices 200 into the top plate 102 and the bottom plate 104 via threading may ensure contact between the battery cell 500 and the thermocouples 302. Thus, by embedding the thermocouple 302 into the thermocouple embedded testing device 200, the thermocouple 302 may be positioned within a fixture, such as the fixture assembly 100, for testing of a battery cell such that degradation of the battery cell and the thermocouple 302 are reduced and contact between the thermocouple 302 and the battery cell is increased.

Turning to FIGS. 5A and 5B, a top view 510 and a side view 520, respectively, of the top plate 102 are shown. Specifically, the side view 520 is a cross section view, showing the top plate along section A-A′ as shown in top view 510. Placement of the battery cell 500 relative to the top plate 102 is also shown, where the dashed line indicates the battery cell 500 may be covered by the top plate 102 in the top view 510. The battery cell 500 may be in face sharing contact with the top plate 102 and the thermocouple embedded testing devices 200 that are positioned in the top plate 102.

The first group of holes 412 may be arranged as shown in FIG. 5A. For example, there may be four holes in the first group of holes 412 arranged symmetrically (e.g., across a y-axis and an x-axis) in corners of the top plate 102. The first group of holes 412 may be configured such that the battery cell 500 does not intersect the first group of holes 412. For example, there may be a larger distance 502 between the first group of holes 412 along the x-axis than dimension 504 of the battery cell 500 along the x-axis.

For example, the first diameter 421 and the second diameter 422 may be approximately 10% larger than the bolt head diameter 431 and the bolt body diameter 432, respectively. In this way, each bolt 402 may be allowed to rotate within one of the first group of holes 412. In at least some examples, there may be a hexagonal recess 506 in each of the bolts 402 which may allow the bolts 402 to be rotated via an appropriately sized hex key.

The third group of holes 420 in which the thermocouple embedded testing devices 200 are inserted may be arranged in the top plate 102 according to desired areas for temperature measurement of the battery cell 500. For example, as shown in FIG. 5A, there may be five thermocouple embedded testing devices 200 inserted into five of the third group of holes 420. In other examples, there may be more or fewer than five thermocouple embedded testing devices 200 in the top plate 102. Further, placement of the thermocouple embedded testing devices 200, and therefore placement of the group of third holes 420, may depend on a number of thermocouple embedded testing devices 200. For example, if a single (e.g., only one) thermocouple embedded testing device 200 is included, the single thermocouple embedded testing device 200 may be positioned at a central point of the battery cell 500 (e.g., midpoint along the x-axis and y-axis) for the most accurate representation of the battery cell 500 temperature. In such an example, the third group of holes 420 may include a single hole positioned in the top plate 102 according to the central point of the battery cell 500. However, more than one thermocouple embedded testing device 200 may be desired to detect the temperature of more than one area of the battery cell 500. For example, if two thermocouple embedded testing devices 200 are included, a first thermocouple embedded testing device 200 may be installed such that a central point of the battery cell 500 is measured, and a second thermocouple embedded testing device 200 may be positioned at a first terminal (e.g., positive or negative) of the battery cell 500. For example, if three thermocouple embedded testing devices 200 are included, a third thermocouple embedded testing device 200 may be positioned at a second terminal (e.g., opposite charge of the first terminal). Further thermocouple embedded testing devices 200 may be included and positioned where a temperature measurement of the adjacent area of the battery cell 500 is desired. The positions described above of thermocouple embedded testing devices 200 and the corresponding third group of holes 420 are exemplary and non-limiting as to an arrangement or a number of thermocouple embedded testing devices, such as the thermocouple embedded testing devices 200, used in a given application, such as testing temperature of a battery cell.

Turning to FIGS. 6A and 6B, a bottom view 610 and a side view 620 are respectively shown, wherein the side view 620 may be a cross section view along the section B-B′ as shown in the bottom view 610. Placement of the battery cell 500 is also shown, where the dashed line indicates the battery cell 500 may be covered by the bottom plate 104 in the bottom view 610.

The second group of holes 414 may be arranged in the bottom plate 104 similar to the first group of holes 412 in the top plate 102 as described above with reference to FIGS. 5A and 5B. The diameter 423 may be smaller than a maximal diameter 602 of the nuts 404. In this way, rotation of the nuts 404 in the second group of holes 414 may be prevented, thus allowing for tightening of the fasteners 106 by rotating the bolts 402 of FIGS. 3-4B while the nuts 404 are rotationally fixed by geometry of the second group of holes 414.

Additionally, the bottom plate 104 may have the same number and configuration of the third group of holes 420, in at least some examples. For example, the bottom plate 104 may have five holes in the third group of holes 420 and five thermocouple embedded testing devices 200 therein. Thus, in at least some examples, the top plate 102 and the bottom plate 104 may have approximately the same shape and dimensions. In other examples, the bottom plate may have different locations and/or different number of thermocouple embedded testing devices 200, depending on desired areas of temperature measurement. By incorporating thermocouple embedded testing devices into the top plate 102 and the bottom plate 104, temperature measurements may be taken on both sides of the battery cell 500 (e.g., a first side in face sharing contact with the top plate 102 and a second side in face sharing contact with the bottom plate 104).

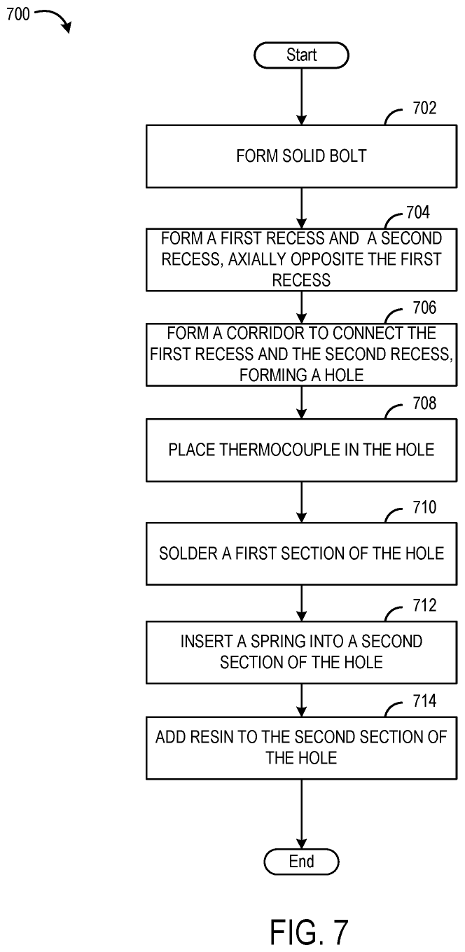

Turning to FIG. 7, a flowchart of a method 700 is shown for forming a thermocouple embedded testing device, such as the thermocouple embedded testing devices 200 of FIGS. 1-5B and 8. For example, the method 700 may be implemented by testing personnel in a testing facility. Additionally or alternatively, the method 700 may be automated and incorporated into an assembly line operated by a control system with stored instructions in the control system's memory including steps of the method 700. Following the method 700, the resulting thermocouple embedded testing device may be incorporated into a fixture, for example the fixture assembly 100, or other system for testing battery cell temperatures.

The method 700 may start at 702, wherein a solid bolt is formed. For example, the solid bolt may be the solid bolt 203 of FIG. 2A. The solid bolt may include a first portion, a second portion, and a third portion (e.g., the hexagonal portion 204, the cylindrical portion 206, and the threaded portion of FIG. 2A). The second portion and the third portion may be a head and a threaded body of solid the bolt. The first portion may be a protrusion from the second portion (e.g., in the opposite direction from the third portion) for placement of the thermocouple embedded testing device following the method 700 (e.g., tightening of the thermocouple embedded testing device into a threaded hole such as the third group of holes 420 of FIGS. 4A-6B).

The method 700 proceeds to 704, wherein a first recess and a second recess axially opposite of the first recess are formed in the solid bolt. For example, the first recess may be formed into the first portion and the second portion such that the first recess extends from a first end of the bolt into the first portion and partially into the second portion. Additionally, the second recess may be formed into the third portion such that the second recess extends from a second end (wherein the first end is axially opposite the second end) into the third portion. The first recess and second recess may be cylindrical, with axial centers thereof aligned with the axial center of the solid bolt. The first recess and second recess may each be a blind hole (e.g., a hole that is closed at one end and open at the other end), defined by a wall (e.g., a cylindrical wall), an end (e.g., a circular end) and an opening (e.g., a circular opening).

The method 700 proceeds to 706, wherein a corridor is formed to connect the first recess and the second recess, thereby forming a through hole (e.g., a hole which includes an opening at each end) which may extend axially from the first end through the first portion, the second portion, and the third portion to the second end. For example, a bolt body (e.g., the bolt body 201 of FIG. 2B) with a through hole (e.g., the hole 211 of FIG. 2B) may be formed from the solid bolt formed at 702 (e.g., the solid bolt 203 of FIG. 2A) by completing 704 and 706.

The method 700 proceeds to 708, wherein a thermocouple is placed in the hole. For example, the thermocouple 302 may be placed in the hole 211 of the thermocouple embedded testing device 200 as shown in FIG. 3A, such that the first end 112 of the thermocouple 302 reaches the bottom opening 234 at an end adjacent to the threaded portion 208 of the bolt body 201. In this way, the thermocouple may be positioned so as to measure temperature of a material placed in face sharing contact with the end of the threaded portion. The hole may comprise a constriction, or a section with a reduced diameter (e.g., the second section 207 of FIG. 3A). In this way, the thermocouple may be stabilized in a desired alignment within the bolt (e.g., vertical alignment of the thermocouple 302 in the hole 211 as shown in FIG. 3A) to facilitate insertion of a spring in a subsequent step of the method 700.

The method 700 proceeds to 710, wherein a first section of the hole is soldered. The first section, as described above, may be within the threaded portion of the bolt body. Thus, with the thermocouple held in the position of 708, the thermocouple may be soldered to the bolt body by adding solder metal (e.g., lead or lead alloy) through a first opening which defines a first end of the hole to fill the first section. For example, the second material 308 (e.g., solder metal) may be added to the third section 209 as shown in FIG. 3A such that the thermocouple 302 is positioned with the first end 112 at the bottom opening 234 which defines the hole 211 at the threaded portion 208. After the solder metal solidifies, any protruding pieces of solidified solder metal may be sanded down (e.g., using sandpaper) such that the solder metal is flush with the end of the threaded portion. In this way, the thermocouple may be in face sharing contact with a surface which is in face sharing contact with the threaded portion, without interference by protrusions of solder metal.

The method 700 proceeds to 712, wherein a spring is inserted into a second section of the hole. The spring may be positioned such that the spring extends through a second opening which defines a second end of the hole, wherein the first opening is axially opposite of the second opening and the first end is axially opposite of the second end. The spring may be spaced away from the solder metal. Further, the spring may circumferentially surround part of the thermocouple. In other words, the thermocouple may be threaded through the spring. For example, as shown in FIG. 3A, the spring 304 may be positioned in the first section 205 such that the spring extends through the top opening 232 and circumferentially surrounds part of the thermocouple 302. The thermocouple may extend through the spring and further, beyond an end of the spring which is external to the bolt body (e.g., not within the hole). Again using the thermocouple embedded testing device 200 in FIG. 3A as an example, the second end 114 of the thermocouple 302 may be external to both the bolt body 201 and the spring 304.

The method 700 proceeds to 714, wherein resin is added to the second section of the hole. For example, epoxy resin may be added to fill the remainder of the hole that is not filled by solder metal. The resin may be allowed to solidify (e.g., over a period of up to 72 hours) with the spring and thermocouple positioned as described above, thus fixing the spring and thermocouple in place relative to the bolt body which is filled with solder and resin.

The method 700 ends after 714, having formed a thermocouple embedded testing device, such as the thermocouple embedded testing device 200 of FIGS. 1 and 3A-6B. Thus, the method 700 may be repeated to create a plurality of thermocouple embedded testing devices, for example to be utilized in a fixture assembly such as the fixture assembly 100.

The technical effect of the thermocouple embedded testing devices disclosed herein is to removably couple one or more thermocouples into a fixture assembly wherein a battery cell may be fixed in order to sense temperatures of areas of the battery cell without causing degradation of the thermocouples or the battery cell. Rather than positioning thermocouples and in parallel with the plates of the fixture assembly and between one of the plates and the battery cell where axial compressive forces experienced by the thermocouples may cause degradation to the battery cell and the thermocouples, the thermocouple embedded testing devices may position the thermocouples thereof perpendicularly to and extending through the top plate and the bottom plate of the fixture assembly such that the thermocouples may not experience opposing axial compressive forces between the top plate and the bottom plate. Further, fastening of the thermocouple embedded testing devices into plates of the fixture assembly may increase surface contact with the battery cell, thereby increasing surface contact between ends of the thermocouples and areas of the battery cell to be measured by the thermocouples. Thus, fastening thermocouple embedded testing devices into plates of a fixture assembly may lead to more accurate temperature measurements, resulting in more confident results compared to other methods of coupling thermocouples to a battery cell.

The disclosure also provides support for a thermocouple embedded testing device, comprising: a head portion filled with a first material, a threaded portion filled with a second material, and a thermocouple positioned within the testing device and extending from the head portion to the threaded portion. In a first example of the system, the first material comprises epoxy resin. In a second example of the system, optionally including the first example, the second material comprises lead. In a third example of the system, optionally including one or both of the first and second examples, the head portion comprises a spring. In a fourth example of the system, optionally including one or more or each of the first through third examples the head portion comprising a hexagonal protrusion for tightening of the thermocouple embedded testing device into a threaded hole. In a fifth example of the system, optionally including one or more or each of the first through fourth examples, the head portion and the threaded portion are a third material comprising polypropylene. In a sixth example of the system, optionally including one or more or each of the first through fifth examples, a first end of the thermocouple is coplanar with an end of the threaded portion, wherein the first end is axially opposite the head portion. In a seventh example of the system, optionally including one or more or each of the first through sixth examples, a second end of the thermocouple extends beyond the head portion, wherein the second end is axially opposite the threaded portion. In an eighth example of the system, optionally including one or more or each of the first through seventh examples, the threaded portion is adapted to removably couple with a threaded hole in a plate such that the thermocouple extends from a first side of the plate to a second side of the plate, wherein the second side is opposite the first side.

The disclosure also provides support for a thermocouple embedded testing device, comprising: a bolt body with a hole extending axially therethrough, a thermocouple extending through the hole, and a first material filling a first section of the hole and a second material filling a second section of the hole, the first material and the second material fixing the thermocouple relative to the bolt body. In a first example of the system, the system further comprises: a spring positioned in the first section and circumferentially surrounding the thermocouple. In a second example of the system, optionally including the first example, a first end of the thermocouple is coplanar with a second end of the bolt body such that a battery cell placed in face sharing contact with the second end is also in face sharing contact with the first end. In a third example of the system, optionally including one or both of the first and second examples, the bolt body includes a threaded portion adapted to be removably coupled with a threaded hole in a fixture. In a fourth example of the system, optionally including one or more or each of the first through third examples, the first material and the second material surround the thermocouple and space the thermocouple away from walls of the bolt body that define the hole.

The disclosure also provides support for a fixture assembly, comprising: a top plate, a bottom plate, a battery cell interposed between the top plate and the bottom plate, a plurality of fasteners adapted to fasten the top plate and the bottom plate together, and a plurality of thermocouple embedded testing devices, wherein a first group is fastened into the top plate and a second group is fastened into the bottom plate. In a first example of the system, the thermocouple embedded testing devices each include a thermocouple which may sense a temperature of an area of the battery cell which is in contact with the thermocouple and transmit a corresponding electrical signal. In a second example of the system, optionally including the first example, the battery cell is in face sharing contact with the first group and the second group when in face sharing contact with the top plate and the bottom plate. In a third example of the system, optionally including one or both of the first and second examples, the first group is removably coupled to the top plate via threaded connections and the second group is removably coupled to the bottom plate via threaded connections. In a fourth example of the system, optionally including one or more or each of the first through third examples, thermocouples of the thermocouple embedded testing devices are positioned approximately perpendicular to the top plate and the bottom plate. In a fifth example of the system, optionally including one or more or each of the first through fourth examples, thermocouples of the thermocouple embedded testing devices extend through an entire thickness of the top plate or the bottom plate.

In another representation, a method of forming a thermocouple embedded testing device may comprise: forming a hole in a solid bolt; placing a thermocouple in the hole; soldering a first section of the hole; inserting a spring into a second section of the hole; and adding resin to the second section of the hole.

In another representation, a fixture assembly may include: a top plate; a bottom plate; a battery cell interposed between the top plate and the bottom plate, wherein the battery cell is adapted to electrically couple to a motor in an electric powertrain of a hybrid or pure battery vehicle; a plurality of fasteners adapted to fasten the top plate and the bottom plate together; and a plurality of thermocouple embedded testing devices, wherein a first group is fastened into the top plate and a second group is fastened into the bottom plate.

FIGS. 1-6B are not shown to scale. For example, a thermocouple embedded testing device may have different dimensions than shown, without departing from the scope of this disclosure. Dimensions may also be different relative to other dimensions, unless specifically stated as being greater than, approximately equal to, or less than another dimension. Further, a thermocouple embedded testing device may include different shapes than described above. For example, a hexagonal portion for tightening may be of any other shape which is conducive to tightening. The fixture assembly 100 is also exemplary in nature and non-limiting. One or more thermocouple embedded testing device assemblies, such as the thermocouple embedded testing device 200, may be included in other fixture assembly embodiments, or any appropriate fixture, including a battery installation or testing assembly.

FIGS. 1-6B show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

Moreover, unless explicitly stated to the contrary, the terms “first,” “second,” “third,” and the like are not intended to denote any order, position, quantity, or importance, but rather are used merely as labels to distinguish one element from another. The subject matter of the present disclosure includes all novel and non-obvious combinations and sub-combinations of the various systems and configurations, and other features, functions, and/or properties disclosed herein.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A thermocouple embedded testing device, comprising:
a head portion filled with a first material;
a threaded portion filled with a second material; and
a thermocouple positioned within the testing device and extending from the head portion to the threaded portion.

2. The thermocouple embedded testing device of claim 1, wherein the first material comprises epoxy resin.

3. The thermocouple embedded testing device of claim 1, wherein the second material comprises lead.

4. The thermocouple embedded testing device of claim 1, wherein the head portion comprises a spring.

5. The thermocouple embedded testing device of claim 1, the head portion comprising a hexagonal protrusion for tightening of the thermocouple embedded testing device into a threaded hole.

6. The thermocouple embedded testing device of claim 1, wherein the head portion and the threaded portion are a third material comprising polypropylene.

7. The thermocouple embedded testing device of claim 1, wherein a first end of the thermocouple is coplanar with an end of the threaded portion, wherein the first end is axially opposite the head portion.

8. The thermocouple embedded testing device of claim 1, wherein a second end of the thermocouple extends beyond the head portion, wherein the second end is axially opposite the threaded portion.

9. The thermocouple embedded testing device of claim 1, wherein the threaded portion is adapted to removably couple with a threaded hole in a plate such that the thermocouple extends from a first side of the plate to a second side of the plate, wherein the second side is opposite the first side.

10. A thermocouple embedded testing device, comprising:
a bolt body with a hole extending axially therethrough;
a thermocouple extending through the hole; and
a first material filling a first section of the hole and a second material filling a second section of the hole, the first material and the second material fixing the thermocouple relative to the bolt body.

11. The thermocouple embedded testing device of claim 10, further comprising a spring positioned in the first section and circumferentially surrounding the thermocouple.

12. The thermocouple embedded testing device of claim 10, wherein a first end of the thermocouple is coplanar with a second end of the bolt body such that a battery cell placed in face sharing contact with the second end is also in face sharing contact with the first end.

13. The thermocouple embedded testing device of claim 10, wherein the bolt body includes a threaded portion adapted to be removably coupled with a threaded hole in a fixture.

14. The thermocouple embedded testing device of claim 10, wherein the first material and the second material surround the thermocouple and space the thermocouple away from walls of the bolt body that define the hole.

15. A fixture assembly, comprising:
a top plate;
a bottom plate;
a battery cell interposed between the top plate and the bottom plate;
a plurality of fasteners adapted to fasten the top plate and the bottom plate together; and
a plurality of thermocouple embedded testing devices, wherein a first group is fastened into the top plate and a second group is fastened into the bottom plate.

16. The fixture assembly of claim 15, wherein the thermocouple embedded testing devices each include a thermocouple which may sense a temperature of an area of the battery cell which is in contact with the thermocouple and transmit a corresponding electrical signal.

17. The fixture assembly of claim 15, wherein the battery cell is in face sharing contact with the first group and the second group when in face sharing contact with the top plate and the bottom plate.

18. The fixture assembly of claim 15, wherein the first group is removably coupled to the top plate via threaded connections and the second group is removably coupled to the bottom plate via threaded connections.

19. The fixture assembly of claim 15, wherein thermocouples of the thermocouple embedded testing devices are positioned approximately perpendicular to the top plate and the bottom plate.

20. The fixture assembly of claim 15, wherein thermocouples of the thermocouple embedded testing devices extend through an entire thickness of the top plate or the bottom plate.
